(19) United States
(12) Patent Application Publication
(10) Pub. No.: US 2025/0263338 A1
(43) Pub. Date: Aug. 21, 2025

(54) APPARATUS AND PROCESS FOR POST STUCCO TREATMENT AND COOLING

(71) Applicant: UNITED STATES GYPSUM COMPANY, Chicago, IL (US)

(72) Inventors: Te Hua LAU, Glenview, IL (US); Artur KROPIELNICKI, Osiny (PL); Maciej ZIELINSKI, Opole (PL); Mateusz KANOS, Opole (PL); Jacek OSINSKI, Opole (PL)

(73) Assignee: UNITED STATES GYPSUM COMPANY, Chicago, IL (US)

(21) Appl. No.: 18/886,081

(22) Filed: Sep. 16, 2024

Related U.S. Application Data
(60) Provisional application No. 63/553,926, filed on Feb. 15, 2024.

(51) Int. Cl. C04B 11/00; C04B 11/036; C04B 28/14

(52) U.S. Cl. CPC C04B 11/007; C04B 11/036; C04B 28/14

(57) ABSTRACT

The present invention relates to a process and an apparatus to cool and heal calcined stucco particles. The process includes feeding stucco particles into an upper portion of a vessel, and feeding a gas comprising air and water into the lower portion of a vessel, wherein the gas cools and substantially fully encapsulates the stucco particles. The apparatus includes a vessel with a rotating spreader for homogenizing the stucco particles, for use in the process described.

### FIELD OF THE INVENTION

The present invention relates to an improved apparatus and process for cooling and surface coating calcined gypsum stucco (beta-calcium sulfate hemihydrate).

### BACKGROUND OF THE INVENTION

Stucco (also known as calcined gypsum) is formed by calcining gypsum at high temperatures to convert the calcium sulfate dihydrate of the gypsum to calcium sulfate hemihydrate. In a typical continuous calcination process known to one of ordinary skill in the art, a one-step milling-calcining unit is used (for example an impact mill or hammer mill) or a two-step milling-drying unit followed with a kettle is used. In order to form stucco, a temperature of 140-170° C. is needed. The water evaporation and dehydrated stucco dehydration process typically uses hot gas generators, in either direct (mill) or indirect (kettle) heat transfer between exhaust gases and processed mediums. The water of hydration is at least partially driven off and there can be formed either calcium sulfate hemihydrate (CaSO₄·1/2H₂O) (typically provided in the material commonly referred to as “stucco”) or calcium sulfate anhydrite (CaSO₄) or a combination of the two, depending on the temperature and duration of exposure. Calcination of the gypsum to produce the hemihydrate form takes place by the following equation:

CaSO₄·2H₂O→CaSO₄·0.5H₂O+1.5H₂O

The cooling of stucco has been of interest in the gypsum industry for many decades. Stucco is physically and thermodynamically unstable at high temperatures. In order to maintain its quality, the stucco should be quickly aerated and cooled below the temperature of calcination (121° C.). This is especially true when the calcined stucco is to be stored over time. Examples of stucco coolers are U.S. Pat. No. 7,765,813 to Bolind et al. and U.S. Pat. No. 6,138,377 to Bolind et al. assigned to U.S. Gypsum Company, and their disclosures are incorporated herein by reference.

Hot and steamy calcined stucco stored in containers will age over time. This aging process adversely affects many of the desirable properties of the stucco, including pouring consistency, hydration rate, set time, response to accelerator, and potential for strength development. If a storage silo does not empty its contents on a “first-in-first-out” basis, the quality of the stucco removed from storage can vary drastically. Thus, the cooling and de-steaming of calcined stucco before storage is essential to long-term age stability.

Apart from age stability during storage, a further problem is caused by mechanical energy from tube mill grinding during the processing of the stucco. The mechanical energy adds more heat to the stucco, preventing many plants from being able to meet temperature requirements for bagging the stucco. Thus, immediate cooling and de-steaming of hot calcined stucco allows for stucco to be properly bagged.

Prior art processes for stabilizing stucco and the like include drying devices, the walls of which may be heated to 100° C., as in U.S. Pat. Nos. 7,371,278 and 7,748,888 to Bold. Stucco may be healed in other processes with water mist but the particles are held static. See U.S. Pat. No. 10,183,890 to Biguenet. Other prior art processes which cool and de-steam stucco utilize a rotating disc in a plenum having a stucco inlet and a stucco outlet with a fluidization pad and agitator to help mix air and the stucco powder. See U.S. Pat. No. 7,765,813 to Bolind et al.

There also exist methods for the calcination of powdery plaster, according to US Pub. No. 2011/0150750 to Groecke, by subjecting the plaster to flash-calcination, and calcium sulfate dihydrate is converted to calcium sulfate hemihydrate in the reactor, and aging of the stucco occur under dry conditions. Additional methods of continuous conditioning of gypsum plaster are described in US Pub. No. 2012/0060723 to Brosig, which includes sequential healing and cooling. Other methods include healing and cooling (often in dry conditions) the stucco in different vessels, for example in Chinese Patent Application No. 209568013 and European Patent No. 1718445.

In some instances, fluidization or gas agitation has been used during the addition of water to calcined gypsum, such as in U.S. Pat. No. 3,415,910.

### SUMMARY OF THE INVENTION

The present invention is an apparatus and process for cooling and healing hot calcined stucco, such as that used in the production of gypsum boards or plaster products. During healing, the invention employs humid air to coat the particle with moisture which repairs cracks in crystals of beta-calcium sulfate hemihydrate by sealing the cracks formed during the prior calcination of gypsum to form the stucco.

The process cools and heals (also referred to as “surface coats”) calcined stucco via a vessel, which provides for a counter gas stream in the opposite direction (or substantially opposite direction) of the falling stucco, alternatively, optionally a vertical or substantially vertical drop of stucco which is slowed down by a countercurrent air stream including:
feeding stucco particles to an upper portion of a vessel, wherein the stucco particles are 80-160° C. at the feeding;
contacting the stucco particles fed to the vessel with a rotating spreader in the upper portion of the vessel to homogenize or substantially uniformly distribute the stucco particles within the vessel and passing the stucco particles downwardly from the rotating spreader;
feeding gas comprising air and water into the vessel from a side in a lower portion of the vessel and/or bottom of the vessel with positive or negative pressure, wherein the gas flow rate into the vessel is equal to or greater than the stucco flow rate into the vessel, wherein the air is about 0° to 50° C. and the water is at 5 to 80° C. before combining with the air, and the water flow rate is at 0.1 to 4% by weight of the flow rate of the stucco; wherein the gas preferably further comprises one or more conditioning agents before feeding the gas into the vessel; wherein the gas in the vessel cools and substantially fully encapsulates the stucco particles within the vessel for a time of 5 seconds to 2 minutes; and
then discharging the cooled stucco particles from a lower portion of the vessel, wherein the stucco particles are 60-90° C. at the discharging; and
releasing the gas from the upper portion of the vessel.

The apparatus includes:
a vessel, wherein a vertical or substantially vertical drop of stucco from the upper portion of the vessel contacts a countercurrent humid air (gas) stream from the lower portion of the vessel, wherein the vessel comprises a top wall, a bottom wall, sidewalls and a spreader in the upper portion of the vessel. The top wall connected to an upper portion of the sidewalls, the bottom wall connected to a lower portion of the side walls, the vessel has an upper portion and a lower portion; and
an inlet for the stucco particles in the upper portion of the vessel,
a rotating spreader within the upper portion of the vessel for homogenizing or substantially uniformly spreading the stucco particles in the vessel which pass downwardly from the spreader in the vessel,
a gas inlet at a side and/or lower portion of the vessel for feeding a gas comprising air and water as humid air into the lower portion of the vessel for contacting the stucco particles with the gas within the vessel below or substantially below the spreader,
optionally a blower may be connected to the gas inlet to blow the fluidizing gas into the vessel, alternatively a fan or other equipment which generates a pressure that is lower than ambient pressure may be connected to the vessel to draw the gas into the vessel,
an outlet for the stucco particles in the lower portion of the vessel, and
a gas outlet for the gas in the upper portion of the vessel, preferably a filter for removing any remaining stucco particles from the gas, is connected to the gas outlet.

The apparatus can be implemented in a stucco processing line where the stucco may be stored for a period of time after the cooling and healing process. Alternatively, the apparatus can be directly implemented into a gypsum board production line where the stucco is made available for immediate use. Each apparatus may stand alone or several may be connected in series or parallel, depending on the processing output and cooling requirements of the system.

Hot and steamy stucco powder enters the vessel from a calcination kettle at a temperature of in the range of 140 to 170° C. Depending upon the distance and mode of transport from the calcination kettle to the vessel (for example a conveyor belt), the stucco entering the vessel may be at a temperature lower than the temperature exiting the calcination kettle. The stucco may be at a temperature of 90 to 160° C.

In the present invention the hot stucco provides heat to the vessel. For example, the vessel walls are not externally heated.

The vessel typically is a vessel with cylindrical sidewalls connected at an upper end to an upper wall and connected at a lower end to a lower wall. The top wall and an upper portion of the vessel side walls define an upper portion. The bottom wall and a lower portion of the vessel side walls define a lower portion. The vessel transverse cross section can be any shape, including square or rectangular, but generally it is cylindrical. The vessel upper portion has a hot stucco inlet and a gas outlet. The vessel lower portion has an air inlet for admitting humid air which is distributed into the vessel and flows counter to the falling stucco. The lower portion also has a cooled stucco outlet.

Air, preferably supplied by a blower, enters the air inlet. Alternatively, a fan may pull air from the vessel by creating a decrease in pressure in the vessel and the air inlet. Preferably water mist (at about 5 to about 80° C., typically 17 to about 80° C.) is injected into the air to form humidified air prior to the air entering the vessel through the air inlet. The humidified air then passes into vessel and discharges in an upwards direction. The water is supplied in the air at a rate of about 0.1 to 4% by weight of the stucco throughput.

To increase the effectiveness of the stucco distribution, a rotating spreader distributes the stucco particles in a substantially uniform manner in the upper portion of the vessel. The rotating spreader unit may be a disc, propeller or other rotatable surface, mounted to extend transversely on a shaft which is connected to a drive providing 30-60 rpm, preferably 40-55 rpm, and the shaft passes vertically through the top wall of the vessel and extends downward to the disc, propeller or other rotatable surface. Stucco falls onto the disc, propeller or other rotatable surface and due to centrifugal force, it is substantially evenly distributed across the wider area of the vessel, in comparison to a simple drop of stucco into the vessel. Thus, the rotating spreader is spaced a sufficient distance above the gas inlet to provide space for the stucco particles to contact the humidified air below the rotating spreader but above the gas inlet.

Each rotating spreader also has a seal unit to prevent stucco from exiting the vessel at the location of the shaft. The rotating spreader is driven by a motor at an appropriate RPM to insure adequate distribution of the stucco particles. One skilled in the art will recognize that one or more agitators may be used, as described in U.S. Pat. No. 6,138,377.

During the cooling and healing process, the steam from the stucco and the humid air (gas) is forced upward and out of the vessel through the air outlet. A disengagement zone is provided in a plenum at the top of the vessel below the air outlet. The disengagement zone is an upwardly extending portion of the vessel that provides additional vessel space to allow the stucco powder particles to fall back from the exiting gas, thus reducing entrainment of the particles in the gas that exits through the gas outlet.

By operation of the countercurrent of gas and rotating spreader, the stucco is thereby cooled and healed when it reaches the stucco outlet at the lower portion of the vessel. The cooled and healed stucco is typically at a temperature between 60 to 94° C. when it exits the vessel. This temperature is well below the calcination temperature of 121° C. The cooled and healed stucco may then be stored without the risk of substantial adverse effects due to aging, or use in manufacturing processes. Previous coolers, such as the coil cooler described in U.S. Pat. No. 6,138,377 to Bolind et al. have a high initial capital cost. Specifically, the coils and heat transfer fluid system used in a coil cooler are expensive. Also, a much larger coil cooler is required to cool the same stucco throughput compared to the invention described herein. Further, when the stucco cooled with the apparatus described herein is used to make products such as wall board, the amount of water and additives required is reduced when compared to stucco cooled in other ways. Thus, the invention described herein enjoys an economic and performance advantage over the prior art coolers.

### BRIEF DESCRIPTION OF THE DRAWING

FIG. 1 is a front elevational view of the stucco cooling and healing apparatus described herein.

FIG. 2 is an alternative inset of the three-way valve for mist introduction to the air conduit.

### DETAILED DESCRIPTION OF THE INVENTION

In the present invention, the process treats beta-calcium sulfate hemihydrate (“stucco”) from upstream calcining. The particles of beta-calcium sulfate hemihydrate (typically Dp50 (number mean) 10-50 μm) feed into the top of the vessel and discharge from the bottom of the vessel. The stucco is preferably hot at a temperature from 140 to 170° C. when fed to the vessel for better healing effect. In the vessel, the particles of beta-calcium sulfate hemihydrate are cooled and healed but not reacted to any significant extent. The dehydrated CaSO4-(soluble) anhydrite form number III (also known as AIII) in stucco after the calcination process is 0-20% by weight, preferably 0-5% by weight. During healing, the humidity coats the stucco particles with moisture which repairs cracks in crystals of beta-calcium sulfate hemihydrate to seal the cracks. The conditioning agent for healing is water or water with conditioning additives, such as retarding agents and/or dispersing agents, as known in the art.

The present invention typically does not include a curing device.

The present invention typically does not include a drying device.

The present invention directly cools the hot stucco by contact with countercurrent gas.

In the present invention the stucco is not subject to flash calcination upstream of the vessel.

In the present invention the stucco surface is healed by adding humid air.

The humidity of the humid atmosphere in the vessel comes from the water on the hot wet stucco and water, preferably from a water nozzle, which sprays water in the air stream upstream of the gas inlet into the vessel.

The invention feeds gas into the side or lower portion of the vessel via rectangular openings/inlets at the wall of a conical or flat-bottomed lower portion of the vessel, and the outlet is in the upper portion of the vessel. The stucco is fed into the top or side of the vessel and the outlet is in the lower portion of the vessel. The vessel is preferably long and thin, in order to provide a sufficient contact time between the stucco and humid air, and preferably has a conical bottom for easy discharge.

The vessel is typically an empty vessel but for the rotating distributor in the upper portion. However, due to its size, the vessel provides sufficient contact time (at least 5 seconds, preferably at least 40 seconds) to cool and heal stucco. Air flow and water nozzle conditions in the vessel are set to cool and heal the particles of beta-calcium sulfate hemihydrate at substantially the same time in the same vessel.

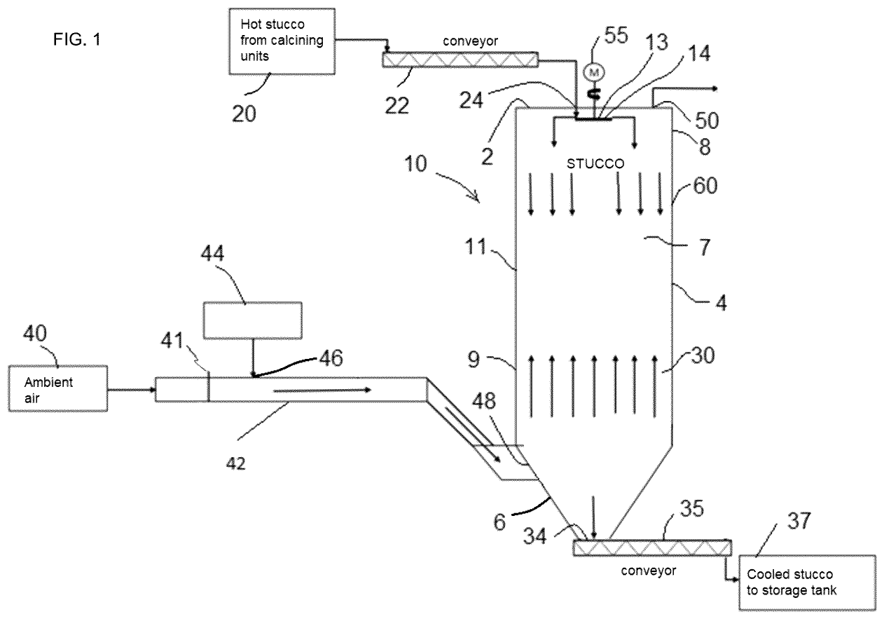

Referring to FIG. 1, an apparatus 10 for cooling and healing hot calcined stucco is shown. The apparatus 10 essentially comprises a vessel 11 having a stucco inlet, a stucco outlet, a humid air inlet, an air outlet, a, and a rotating spreader 13 with a motor or drive M therein. The vessel 11 has a top wall 2, sidewalls 4, and a bottom wall 6. The vessel 11 defines a plenum space 7. The vessel has an upper portion 8 and a lower portion 9. The vessel 11 is generally cylindrical, although other shapes may be used. In an example for processing 20-60 tons of stucco per hour, the vessel is 6 to 7 meters in diameter and approximately 8-12 meters tall. The vessel 11 may have other dimensions, depending upon the application and desired throughput.

The vessel 11 has a stucco inlet 24 located in the upper portion 8, typically in the top wall 2, and a stucco outlet 34, located in the lower portion of vessel 11. The stucco inlet 24 and the stucco outlet 34 are sized to accommodate a flow of stucco desired as the throughput.

Hot and steamy stucco powder enters the vessel 11 from a stucco source 20, typically a calcining unit, such as a calcination kettle, at a temperature typically in the range of 140° C. to 170° C. The hot and steamy stucco flows from the stucco source 20 through a conveyor 22 into the vessel 11 through a stucco inlet 24, into the rotating spreader 13 that distributes the stucco.

The vessel 11 has a gas (humid air) inlet 48 located in the lower portion, and a gas outlet 50, located in the upper portion of vessel 11. Water mist is injected into the air at water inlet 46. The gas inlet 48 and the gas outlet 50 are sized to accommodate a flow of air desired as the throughput. Air typically enters the vessel at a temperature typically in the range of about 0 to 50° C. and a water load for more than 0 to 4% of the stucco throughput. Ambient air from a source of air 40 passes preferably through a blower 41 and then through an air conduit 42, and is mixed with water from a water source 44 injected as mist at a water mist injection point 46, and optionally other conditioning agents are introduced, to humidify the air. Then the hot humid air (also referred to as a gas) passes through a gas inlet 48 to provide the gas to the lower portion of the vessel.

This humid air flows substantially countercurrent to the stucco powder so that the stucco effectively flows downwardly through the vessel 11 with sufficient residence time for cooling and healing the stucco particles. The gas then exits the vessel upwardly through an air outlet 50 in the upper portion 8 of the vessel 11, typically the air outlet 50 is through the vessel upper wall 2.

Thus, the stucco is substantially uniformly distributed in the vessel 11 and is cooled by the humid air that flows upwardly from the lower portion of the vessel. The stucco directly contacts the humid air which is flowing substantially in the counter direction of the stucco and out of the vessel 11 through stucco outlet 34. The discharged cooled stucco from the stucco outlet 34 then feeds a conveyor 35 that conveys the stucco to a storage tank 37, or the cooled stucco can then be bagged, or sent to other processing stations, such as wallboard manufacturing lines.

The stucco cooling and healing apparatus 10 can stand alone or be connected in series or parallel with several other coolers, depending upon the cooling requirements of the system and other factors such as space or height limitations. In a preferred embodiment, the apparatus 10 is compact and upright, thereby minimizing the plant floor area occupied.

Although cylindrical in the preferred embodiment, the vessel 11 may be in any shape. The rotating spreader 13 has a disc or propeller 14 mounted on a shaft that passes through the top of the vessel 11, such that the propeller 14 is positioned in the upper portion of the vessel. The propeller 14 need not be of any particular shape. In the preferred embodiment, the propeller 14 is a pair of [¼]″ wide by 2 inch long stainless steel bars extending transversely from the vertically oriented shaft within the walls of the vessel 11. In a preferred embodiment, the propeller 14 is a flat disc fixed transversely from the vertically oriented, driven shaft within the walls of vessel 11. One will recognize other mechanisms could be used to distribute the stucco, such as a swinging gate agitator. If a rectangular or other non-circular housing is used, the propeller 14 is of a size that allows it to rotate without contacting the walls of a vessel 11.

The rotating spreader 13 is powered to rotate by a motor 55 driving a shaft attached to the propeller 14.

In an embodiment, in order to prevent or reduce the amount of stucco that escapes the vessel 11 through the aperture through which the shaft enters the vessel 11, a positive air pressure seal or other type of seal may be applied to the aperture. Air may be provided to the seal by a conduit from outside the transmission unit to the seal. The conduit may be connected by hoses or piping to a plant source of compressed air. In an embodiment, the air may be regulated to a pressure of 1 psi, or a pressure just sufficient to keep the stucco from exiting the vessel 11 at the aperture. In an embodiment, the motor runs at approximately 60 RPM, although other rotation speeds will work.

The vessel 11 further includes an inspection port. The inspection port can be fitted with a removable metal lid to allow for access in to the vessel 11. The inspection port may also be fitted with a clear lid, allowing observation of the vessel 11 during operation. In alternate embodiments, the inspection port can be left open to the ambient air, or fitted with appropriate duct work, to provide a gas outlet.

In the preferred embodiment, the stucco outlet 34 is in selective fluid communication with a conveyor belt which moves the stucco away from vessel 11. The fluid communication is regulated by a valve, which is normally in the open position. The valve is opened when the operator desires to empty the vessel 11 of stucco. In a preferred embodiment, the stucco outlet 34 is connected with a conveyor 35, for example a screw conveyor, which moves the stucco away from vessel 11.

In a preferred embodiment, a blower introducing low positive air pressure (preferably about 10 mbar or more) having a capacity of approximately between 5,000 to 30,000 actual cubic meters/hour gas flow is utilized. Alternatively, a low negative air pressure may be introduced (about −20 mbar or less) to draw the air into the air inlet and the gas into the vessel.

In any of the embodiments, water is provided to the air conduit 42 by a fluid coupling. The fluid coupling allows a fixed pipe or hose to provide water to the air inlet line. The water may be provided by any number of sources, such as city tap water, a gravity feed tank or a pump, so long as sufficient water can be delivered.

The cooling and healing taking place in the vessel 11 can be regulated by adjusting the amount of humidity and/or conditioning agent in the air. In the preferred embodiment, the water is supplied to a 3-way valve assembly having an input for water and an input for compressed air from the plant compressed air source, and an output for providing any mixture of the two inputs, including all of air or water. The valve output is connected by suitable conduit to air conduit 42. In a typical application, air is delivered at approximately 80 to 100 psi to the valve. The valve is controlled by a controller that receives a signal from a thermocouple or other temperature sensor placed in the vessel 11. When the controller senses a temperature of less than 212° F., it adjusts the valve assembly so that only air is delivered to the air inlet line 19. When the temperature is equal to, or above 220° F., the valve assembly is adjusted so water is delivered to the air inlet line 19. One skilled in the art will recognize that a mixture of air and water could also be delivered, the mixture varying to achieve the desired cooling rate and water usage. In operation, it is preferred that humid air is supplied to the gas inlet any time there is stucco in the vessel 11, to prevent any stucco from clogging the vessel 11 or any portion of the apparatus 10.

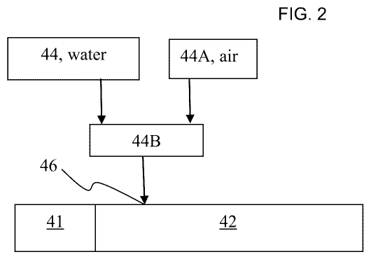

In another embodiment, the cooling and healing taking place in the vessel 11 can be regulated by adjusting the amount of humidity and/or conditioning agent in the air. In a preferred embodiment, the water is supplied to a 3-way valve assembly 44B (shown in FIG. 2) having an input for water 44 and an input for compressed air 44A from the plant compressed air source, and an output for providing any mixture of the two inputs 46, including all of air or water. The mixture varying to achieve the desired cooling rate and water usage. In operation, it is preferred that humid air is supplied to the gas inlet any time there is stucco in the vessel 11, to prevent any stucco from clogging the vessel 11 or any portion of the apparatus 10.

The steam from the stucco is forced upward and out of the vessel 11 through a gas outlet 50. The gas outlet 50 is located at or near the top of the vessel 11. A disengagement zone 60 is in the upper portion 8 of the vessel 11 in which hot gas passes upwardly from the lower portion of the vessel and is disengaged from the majority of the stucco in the vessel. As the gas is passes upwardly through the vessel 11 towards the gas outlet 50, the disengagement zone 30 provides space to allow the stucco powder particles to drop and fall back before possibly entering the gas outlet 50, thereby preventing entrainment of the stucco powder particles in the gas that exits through the gas outlet 50. The gas outlet 50 is typically in fluid communication with a dust collector and a ventilator (not shown), which collects and filters any stucco particle residue entrained within the discharged gas.

In an embodiment, performance requirements of a cooling system can also be met by using more than one vessel 11, either in parallel, or in series. A similar arrangement is described in U.S. Pat. No. 6,138,377. Additionally, if further drying or cooling below 100° C. is desired, the stucco exiting the stucco outlet 15 can be fed to a drier, familiar to one skilled in the art. Any drier that provides a flow of air without adding heat to the stucco may be considered for the drier.

### Clauses of the Invention

The following clauses describe various aspects of the invention.

Clause 1. A process to cool and heal calcined stucco particles, comprising:
feeding stucco particles to an upper portion of a vessel, wherein the stucco particles are 80-160° C. at the feeding;
contacting the stucco particles fed to the vessel with a rotating spreader in the upper portion of the vessel to homogenize or substantially uniformly distribute the stucco particles within the vessel and passing the stucco particles downwardly from the rotating spreader;
feeding gas comprising air and water into the vessel from a side in a lower portion of the vessel and/or bottom of the vessel with positive or negative pressure, wherein the air is about 0° to 50° C. and the water is at 5° to 80° C. before combining with the air, and the water is at 0.1 to 4% by weight of the flow rate of the stucco;

wherein the gas preferably further comprises one or more conditioning agents before feeding the gas into the vessel;
wherein the gas in the vessel cools and substantially fully encapsulates the stucco particles within the vessel for a time of 5 seconds to 2 minutes; and
then discharging the cooled stucco particles from a lower portion of the vessel, wherein the stucco particles are 60-90° C. at the discharging;
and releasing the gas from the upper portion of the vessel.

Clause 2. The process of clause 1, wherein the stucco particles are fed to the upper portion of the vessel at a flow rate in a range of 20-60 tons per hours for a vessel with 8-12 meters height and 6-7 meters diameter; and wherein the gas is fed to the lower portion of the vessel at a flow rate in a range of 5,000-30,000 m³ per hour.

Clause 3. The process of clause 1 or 2, wherein the gas further comprises one or more conditioning agents.

Clause 4. The process of clause 1 or 2, wherein the gas further comprises one or more conditioning agents comprising retarding agents, liquefiers, and water reducing agents, preferably citric acid based retarders and/or poly carboxyl ether dispersing agents.

Clause 5. The process of any of clauses 1 to 4, further comprising directing the gas to a filter after releasing from the vessel.

Clause 6. The process of any of clauses 1 to 5, wherein the stucco particles have a Dp50 of 10-50 um.

Clause 7. The process of any of clauses 1 to 6, wherein the gas has a temperature of 60-100° C. when fed into the vessel.

Clause 8. The process of any of clauses 1 to 7, wherein a temperature of the stucco particles when fed into the vessel is in a range of from 90-140° C.

Clause 9. The process of any of clauses 1 to 8, wherein the vessel is only heated by the stucco fed to the vessel.

Clause 10. An apparatus for cooling and surface coating calcined stucco particles comprising:
a vessel, preferably comprising a top wall, a bottom wall and sidewalls, wherein the top wall is connected to an upper portion of the sidewalls, the bottom wall connected to a lower portion of the side walls, and the vessel has an upper portion and a lower portion; and
an inlet for the stucco particles in the upper portion of the vessel,
a rotating spreader within the upper portion of the vessel for homogenizing or substantially uniformly spreading the stucco particles in the vessel which pass downwardly from the spreader in the vessel,
a gas inlet at a side and/or lower portion of the vessel for feeding a gas comprising air and water as humid air into the lower portion of the vessel for contacting the stucco particles with the gas within the vessel below or substantially below the spreader,
optionally a blower may be connected to the gas inlet to blow the fluidizing gas into the vessel, alternatively a fan or other equipment which generates a pressure that is lower than ambient pressure may be connected to the vessel to draw the gas into the vessel,
an outlet for the stucco particles in the lower portion of the vessel, and
a gas outlet for the gas in the upper portion of the vessel, preferably a filter is connected to the gas outlet.

Clause 11. The apparatus of clause 10, wherein the rotating spreader comprises a rotatable propeller.

Clause 12. The apparatus of clause 10 or 11, further comprising an inlet for feeding one or more conditioning agents into the air and/or gas before the gas inlet to the vessel.

Clause 13. The apparatus of clause 10 or 11, further comprising an inlet for feeding one or more conditioning agents, comprising retarding agents, liquefiers, and water reducing agents, preferably citric acid based retarders and/or poly carboxyl ether dispersing agents, into the air and/or gas before the gas inlet to the vessel.

Clause 14 The apparatus of any of clauses 10 to 13, further comprising a water injector for injecting water into the air before entering the vessel through the gas inlet.

Clause 15. The apparatus of any of clauses 10 to 14, further comprises a water injector for injecting water into the air comprising the conditioning agents before entering the vessel through the gas inlet.

Clause 16. The apparatus of any of clauses 10 to 15, wherein the gas inlet is in the sidewall of the vessel, preferably the sidewall of the lower portion of the vessel.

Clause 17. The apparatus of any of clauses 10 to 15, wherein the gas inlet is in the bottom wall of the vessel.

Clause 18. The apparatus of any of clauses 10 to 17, wherein the vessel is sized to allow the stucco particles to be cooled and healed in the vessel.

While specific embodiments of the present invention have been shown here for the purposes of explaining preferred and alternate embodiments of the invention, it is to be understood that the appended claims have a wide range of equivalents and a broader scope than the embodiments disclosed.

1. A process to cool and heal calcined stucco particles, comprising:
feeding stucco particles to an upper portion of a vessel, wherein the stucco particles are 80-160° C. at the feeding;
contacting the stucco particles fed to the vessel with a rotating spreader in the upper portion of the vessel to homogenize or substantially uniformly distribute the stucco particles within the vessel and passing the stucco particles downwardly from the rotating spreader;
feeding gas comprising air and water into the vessel from a side in a lower portion of the vessel and/or bottom of the vessel with positive or negative pressure, wherein the air is about 0° to 50° C. and the water is at 5 to 80° C. before combining with the air, and the water is at 0.1 to 4% by weight of the flow rate of the stucco;
wherein the gas preferably further comprises one or more conditioning agents before feeding the gas into the vessel;
wherein the gas in the vessel cools and substantially fully encapsulates the stucco particles within the vessel for a time of 5 seconds to 2 minutes; and
then discharging the cooled stucco particles from a lower portion of the vessel, wherein the stucco particles are 60-90° C. at the discharging;
and
releasing the gas from the upper portion of the vessel.

2. The process of claim 1, wherein the stucco particles are fed to the upper portion of the vessel at a flow rate in a range of 20-60 tons per hours for a vessel with 8-12 meters height and 6-7 meters diameter; and wherein the gas is fed to the lower portion of the vessel at a flow rate in a range of 5,000-30,000 m³ per hour.

3. The process of claim 1, wherein the gas further comprises one or more conditioning agents.

4. The process of claim 1, wherein the gas further comprises one or more conditioning agents comprising retarding agents, liquefiers, and water reducing agents, preferably citric acid based retarders and/or poly carboxyl ether dispersing agents.

5. The process of claim 1, further comprising directing the gas to a filter after releasing from the vessel.

6. The process of claim 1, wherein the stucco particles have a Dp50 of 10-50 μm.

7. The process of claim 1, wherein the gas has a temperature of 60-100° C. when fed into the vessel.

8. The process of claim 1, wherein a temperature of the stucco particles when fed into the vessel is in a range of from 90-140° C.

9. The process of claim 1, wherein the vessel is only heated by the stucco fed to the vessel.

10. An apparatus for cooling and surface coating calcined stucco particles comprising:
a vessel, preferably comprising a top wall, a bottom wall and sidewalls, wherein the top wall is connected to an upper portion of the sidewalls, the bottom wall connected to a lower portion of the side walls, and the vessel has an upper portion and a lower portion; and
an inlet for the stucco particles in the upper portion of the vessel,
a rotating spreader within the upper portion of the vessel for homogenizing or substantially uniformly spreading the stucco particles in the vessel which pass downwardly from the spreader in the vessel,
a gas inlet at a side and/or lower portion of the vessel for feeding a gas comprising air and water as humid air into the lower portion of the vessel for contacting the stucco particles with the gas within the vessel below or substantially below the spreader,
optionally a blower may be connected to the gas inlet to blow the fluidizing gas into the vessel, alternatively a fan or other equipment which generates a pressure that is lower than ambient pressure may be connected to the vessel to draw the gas into the vessel,
an outlet for the stucco particles in the lower portion of the vessel, and
a gas outlet for the gas in the upper portion of the vessel, preferably a filter is connected to the gas outlet.

11. The apparatus of claim 10, wherein the rotating spreader comprises a rotatable propeller.

12. The apparatus of claim 10, further comprising an inlet for feeding one or more conditioning agents into the air and/or gas before the gas inlet to the vessel.

13. The apparatus of claim 10, further comprising an inlet for feeding one or more conditioning agents, comprising retarding agents, liquefiers, and water reducing agents, preferably citric acid based retarders and/or poly carboxyl ether dispersing agents, into the air and/or gas before the gas inlet to the vessel.

14. The apparatus of claim 10, further comprising a water injector for injecting water into the air before entering the vessel through the gas inlet.

15. The apparatus of claim 10, further comprises a water injector for injecting water into the air comprising the conditioning agents before entering the vessel through the gas inlet.

16. The apparatus of claim 10, wherein the gas inlet is in the sidewall of the vessel, preferably the sidewall of the lower portion of the vessel.

17. The apparatus of claim 10, wherein the gas inlet is in the bottom wall of the vessel.

18. The apparatus of claim 10, wherein the vessel is sized to allow the stucco particles to be cooled and healed in the vessel.

19. The process of claim 2, wherein the gas further comprises one or more conditioning agents comprising retarding agents, liquefiers, and water reducing agents, preferably citric acid based retarders and/or poly carboxyl ether dispersing agents.

20. The process of claim 7, wherein a temperature of the stucco particles when fed into the vessel is in a range of from 90-140° C.
